(19) United States
(12) Patent Application Publication
(10) Pub. No.: US 2008/0104661 A1
(43) Pub. Date: May 1, 2008

(54) Managing Policy Settings for Remote Clients

(76) Inventors: Joseph Levin, Arlington, MA (US); Danny Kim, Bellevue, WA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/680,924

(22) Filed: Mar. 1, 2007

Related U.S. Application Data
(60) Provisional application No. 60/854,944, filed on Oct. 27, 2006.

(51) Int. Cl. H04L 9/00

(52) U.S. Cl. 726/1

(57) ABSTRACT

A method for managing group policy settings at a client computer system includes storing group policy settings in a local policy cache of the client computer system and applying the group policy settings from the local policy cache to the client computer system. The group policy settings may be acquired from a policy portal over a network connection and the local policy cache of the client computer system updated with the acquired group policy settings. A policy portal may be queried over a network connection to determine an age of group policy settings stored at the policy portal. If the group policy settings in the local policy cache are older than the group policy settings stored at the policy portal, the group policy settings are acquired from the policy portal for updating the local policy cache. If the local policy cache does not contain group policy settings, group policy settings may be acquired from a policy portal for updating the local policy cache. A method for managing group policy settings on one or more client computer systems includes receiving a request for group policy settings from a client computer system over a network and sending group policy settings to the client computer system in response to the client request. A domain associated with the client computer system is determined and group policy settings are requested from a domain controller corresponding to the determined domain. The group policy settings associated with the client computer system may be retrieved from a policy settings database.

### RELATED APPLICATION

This application claims the benefit of U.S. Provisional Application No. 60/854,944, filed on Oct. 27, 2006. The entire teachings of the above application are incorporated herein by reference.

### BACKGROUND

Group policy is a concept that enables various user and computer settings to be defined and managed centrally on a network. In the Microsoft Windows environment, “Group Policy” and “Active Directory” services infrastructure in Windows Server 2003 enable information technology (IT) administrators to automate one-to-many management of users and computers—simplifying administrative tasks and reducing management costs.

Group policy has many advantages including centralizing computer system settings for various computer systems at a domain, site and/or organizational unit (OU) level in order to enforce uniformity across the computer systems; allowing the application of different policies to different sites, domains and OUs in order to manage, e.g., different sets of users; enabling user desktop environments to be managed in order to reduce, e.g., time spent troubleshooting configuration problems; enabling the installation, update, repair and removal of software on various computer systems to be centrally managed; and enabling the creation and management of account policies, audit policies and other security features in order to manage the security of computers and users in, e.g., a domain.

Group policy objects (GPOs) are often employed to implement certain policies on a computer system. A GPO is a structure that contains a collection of computer settings associated with a group policy. For example, a GPO may contain settings that determine access rights and privileges for a particular user when the user logs into a computer system. GPOs may be configured to perform various management tasks on a computer system, such as distributing registry settings, distributing security settings and/or deploying software. Further, GPOs may be configured to implement other policy related functions, such as establishing roaming user profiles and redirecting file system folders to, e.g., a network share file system. In a typical arrangement, a system administrator creates a GPO and targets it to a particular site, domain and/or organizational unit. The GPO is delivered to the appropriate computer systems which are then configured according to the contents of the GPO.

GPOs are stored on the domain controllers or on the client machines; GPOs stored on client machines are called local GPOs or LGPOs. Policy settings are acquired from both the GPOs on the domain controller (DC) and from the local GPOs and applied to the system.

A GPO may be organized into various types of policies including, for example, administrative templates, folder redirection, security settings, and software installation. Each policy type may, in turn, be configured to support a number of policy settings. For example, a GPO may contain administrative template settings that both hide icons on a user's desktop and prevent the user from running certain applications.

Policy settings are applied to a computer system when the system is started, a user logs into the system, a user logs out of the system or when the system is shut down. Additionally the settings for the system and user may be refreshed at regular intervals. For DCs, the policy settings are typically refreshed every five minutes. For client computers, the policy settings are typically refreshed every ninety minutes plus a random offset of up to thirty minutes. In addition, certain policy settings, such as policy settings associated with software installation and folder redirection, may be applied only when the system starts up or when a user logs into the system, and are not refreshed periodically.

### SUMMARY

Group policy provides a single point of security and management for devices that are connected in a directory based environment such as Active Directory. However, there are situations where organizations cannot take advantage of group policy to manage computers and other devices using native group policy. Organizations that operate in a directory-based environment but have devices that are temporarily or permanently outside the directory require the ability to centrally enforce standard policies on all devices. Organizations that do not operate in a directory based environment still need to be able to maintain standard, secure configurations on endpoint devices.

Directory based environments supply enterprises with powerful, hierarchical mechanisms for describing and managing their resources. The central role that directories play in an enterprise means that access to directories is typically limited to devices that meet two requirements, namely, that they are trusted and that they reside on the enterprise LAN. In Windows, trust is defined by domain membership. Each Windows domain has its own Active Directory instance. Devices that are a member of a domain have a trust relationship with the Active Directory servers or domain controllers and apply group policy settings read from these servers.

Today a large portion of devices are managed by group policy but there are a significant number of devices that do not and cannot meet the two requirements noted above. There are four distinct scenarios that arise from these requirements:
Devices that are both domain members and resident on the LAN apply group policy using the native infrastructure without difficulty.
Devices that are domain members but are not resident on the LAN are set up to apply group policy but do not have the physical access to read settings. A typical example of this scenario is a mobile device (e.g., a laptop) that is used outside of the enterprise LAN the majority of the time.
Devices that are on the LAN but are not members of a domain. This scenario will occur if access to domain resources in general needs to be limited for a device. If there is a requirement to keep a device isolated, say for security reasons, domain membership may be precluded.
Devices that are neither on the LAN nor are domain members. Examples of this include systems that users maintain at home, remote kiosk machines, and laptops that are not domain members.

Of these four scenarios, only the first one is generally fully addressed by group policy as implemented today. Yet, enterprises own, and need to manage, devices that are classified under all four scenarios.

Accordingly, embodiments of the present invention provide a web services-based approach that allows organizations to automatically enforce group policy settings on machines that are temporarily or permanently disconnected from the directory-based environment. With the present approach, organizations are able to maintain the security of network endpoints by extending directory-based policy management over the Internet. In addition, IT administrators can create, deploy and automatically enforce security policies without human intervention on any target machine with an Internet or Intranet connection. At defined intervals, targeted endpoint devices may transparently connect to a policy portal server to check for policy updates and reset configurations that may have fallen out of compliance.

A method for managing group policy settings at a client computer system comprises storing group policy settings in a local policy cache of the client computer system and applying the group policy settings from the local policy cache to the client computer system. In one aspect, group policy settings may be acquired from a policy portal over a network connection and the local policy cache of the client computer system updated with the acquired group policy settings. In another aspect, the policy portal may be queried to determine an age of group policy settings stored at the policy portal. If the group policy settings in the local policy cache are older than the group policy settings stored at the policy portal, the group policy settings may be acquired from the policy portal for updating the local policy cache. If the local policy cache does not contain group policy settings, then group policy settings may be acquired from the policy portal.

A method for managing group policy settings on one or more client computer systems comprises receiving a request for group policy settings from a client computer system over a wide-area network and sending group policy settings to the client computer system in response to the client request. In one aspect, a domain associated with the client computer system may be determined and group policy settings requested from a domain controller corresponding to the determined domain. In another aspect, the group policy settings associated with the client computer system may be retrieved from a policy settings database.

### BRIEF DESCRIPTION OF THE DRAWINGS

The foregoing and other features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a first embodiment of a communication network.

FIG. 2 is a block diagram of a managed client.

FIG. 3A is a block diagram of a domain controller.

FIG. 3B is a block diagram of a policy portal proxy.

FIG. 4 is a block diagram of a policy portal server.

FIG. 5 illustrates a flowchart of a sequence that may be used to update policy settings on a managed client.

FIG. 6A illustrates a flowchart of a sequence that may be used to update a policy portal with policy settings established at a customer domain.

FIG. 6B illustrates a flowchart of a sequence that may be used to obtain resultant set of policy results.

FIG. 7 illustrates a flowchart of a sequence that may be used by an administrator node to maintain group policy objects at the policy portal.

FIG. 8 illustrates a flowchart of a sequence that may be used by an administrator node to associate managed clients with policy settings at a policy portal.

FIG. 9 illustrates a flowchart of a sequence that may be used to update a managed client with policy settings associated with that managed client.

FIG. 10 illustrates a flowchart of a first sequence that may be used by a policy portal to update policy settings of a managed client.

FIG. 11 is a block diagram of a second embodiment of a communication network.

FIG. 12 illustrates a flowchart of a second sequence that may be used by a policy portal to update policy settings of a managed client.

### DETAILED DESCRIPTION

It should be noted that, illustrative embodiments of the present invention, described herein, are described as using the Microsoft Windows operating system. The Microsoft Windows operating system is available from Microsoft Corporation. It should be noted that other operating systems may be adapted to be used with the present invention including e.g., Unix, and Linux.

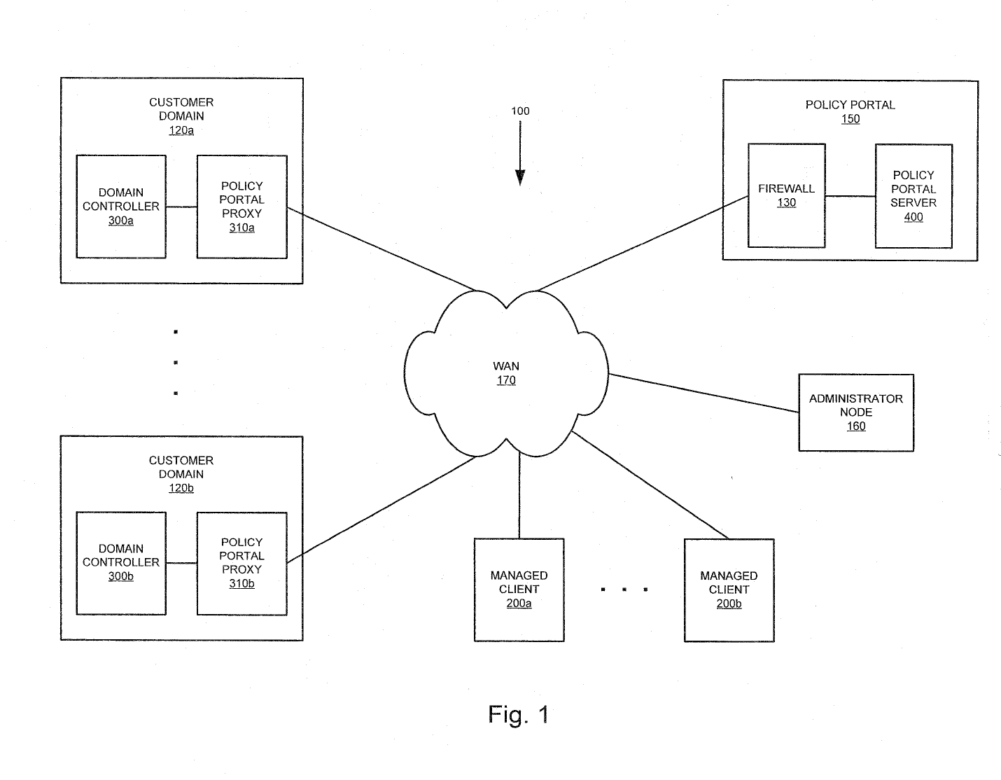

FIG. 1 is a high level block diagram of a first embodiment of an exemplary communication network. Network 100 comprises a plurality of nodes, such as administrator node 160, one or more managed clients 200, one or more policy portal proxy nodes 310, one or more domain controllers 300, and a policy portal 150 comprising a firewall 130 and policy portal server 400, interconnected via wide-area network 170 to form an internetwork of nodes. These internetwork nodes communicate by exchanging data packets according to a pre-defined set of network protocols, such as the transmission control protocol/Internet protocol (TCP/IP) remote desktop protocol (RDP), and the like. A network protocol as used herein is a formal set of rules that define how data is exchanged between nodes on a communication network.

A policy portal is used herein to refer to a non-domain controller node that hosts group policy settings and provides such group policy settings to client nodes.

The managed client nodes 200 are conventional network nodes, such as personal computers, personal digital assistants (PDAs) and the like, that are capable of establishing a connection with the policy portal server 400 to download and apply various policy settings from the policy portal server 400 to the client nodes 200. The managed client may or may not be a member of a customer domain.

The administrator node 160 is a conventional network node, such as a personal computer, that is used by an administrator as will be described further below, to maintain group policy objects (GPOs) as well as settings for associating the managed clients 200 with various GPOs that are to be applied to the managed client in accordance with an aspect of the present invention.

The policy portal proxy nodes 310 and domain controller nodes 300 are located in various customer domains 120 and contain various group policy settings (e.g., GPOs) that are applied to the various managed clients 200 via the policy portal 150 in accordance with an aspect of the present invention. Specifically, each customer domain 120 comprises a domain controller 300 and a policy portal proxy 310. The domain controller 300 is a conventional node, such as a server node, configured to implement a Microsoft server system domain controller. Each domain controller 300 comprises an active directory which contains various settings relating to policies that are associated with the customer domain 120. These settings may include for example, user and computer objects as well as group policy objects. A group policy object as used herein is an object that stores various policy settings. Group policy objects can be local and non-local. Local group policy objects are stored on an individual computer and typically only one local group policy object exists on a computer. A local group policy object may be overwritten by a non-local group policy object. Non-local group policy objects typically reside on a domain controller and are available only in an active directory environment. A non-local group policy object may apply to users and computers at a site, domain or an organizational unit with which the group policy object is associated.

The policy portal proxy 310 is a conventional proxy node that is configured to interface a domain controller 300 and a customer domain 120 with the policy portal 150.

As noted above, the policy portal 150 comprises a firewall 130 and a policy portal server 400. The firewall is a conventional firewall configured to control access to the policy portal 150 via the network 100. The policy portal server 400 is a conventional server configured to maintain group policy settings and download those settings to the managed clients 200 in accordance with aspects of the present invention.

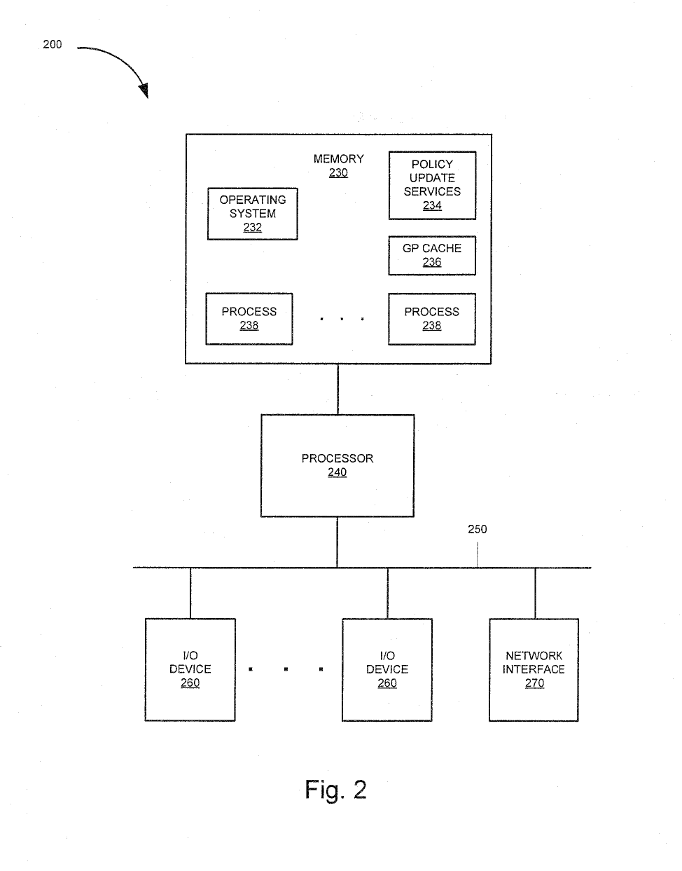

FIG. 2 is a block diagram of an embodiment of a managed client 200. Managed client 200 comprises a memory 230 coupled to a processor 240 which in turn is coupled to one or more input/output (I/O) devices 260 and a network interface 270 via an I/O bus 250. The I/O devices are conventional I/O devices such as disk units, keyboards, displays and the like.

The network interface 270 comprises circuitry configured to interface the managed client 200 with the network 100. To that end, the network interface 270 comprises conventional interface circuitry that incorporates signal, electrical, and mechanical characteristics and interchange circuits needed to interface with the physical media of the network 100 and protocols running over that media.

The processor 240 is a conventional central processing unit (CPU) configured to execute instructions and manipulate data contained in the memory 230. The memory 230 is a conventional random access memory (RAM) comprising, e.g., dynamic RAM (DRAM) devices. Memory 230 contains an operating system 232 and policy update services 234. It should be noted that memory 230 may contain other processes 238 that are used to perform various functions on the managed client 200.

The operating system 232 is a conventional operating system that comprises computer executable instructions and data configured to support the execution of processes, such as policy update services 234. Specifically, operating system 232 is configured to perform various conventional operating system functions that, e.g., enable processes to be scheduled for execution on the processor 240 as well as provide controlled access to various resources of the managed client 200, such as memory 230.

The policy update services 234 comprises computer executable instructions and data configured to, as will be described further below, acquire and apply various group policy settings to the managed client 200. The group policy cache 236 is a data structure configured to hold a copy of various group policy settings, acquired from a policy portal server 400, that are to be applied to the managed client 200. The group policy cache serves as a local resident copy of the group policy settings that were received from the server. The mechanism for retrieving group policy settings from the server and for updating the cache is independent of the mechanism for applying group policy settings, from the cache, to the client.

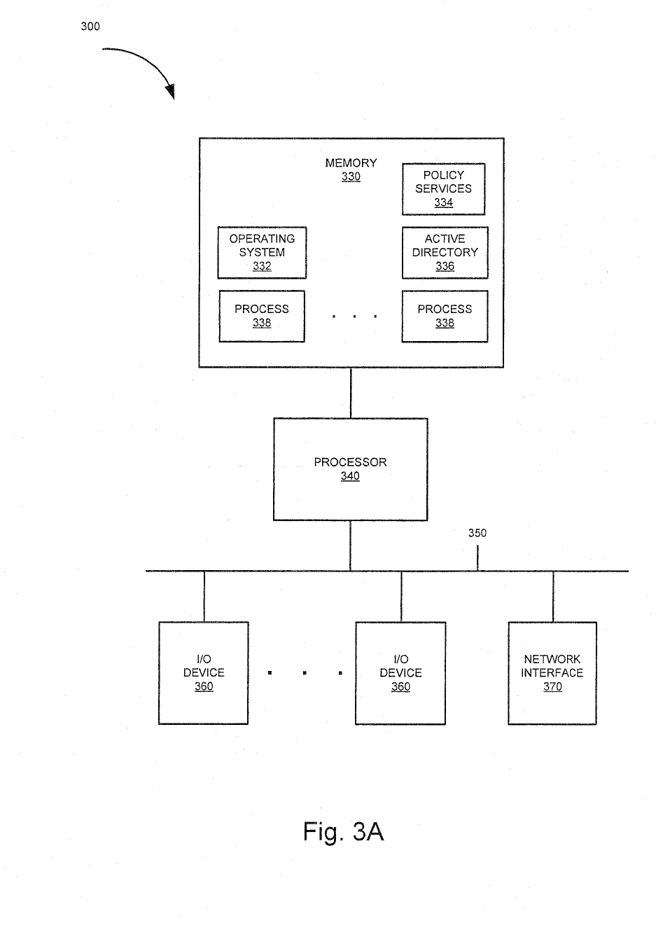

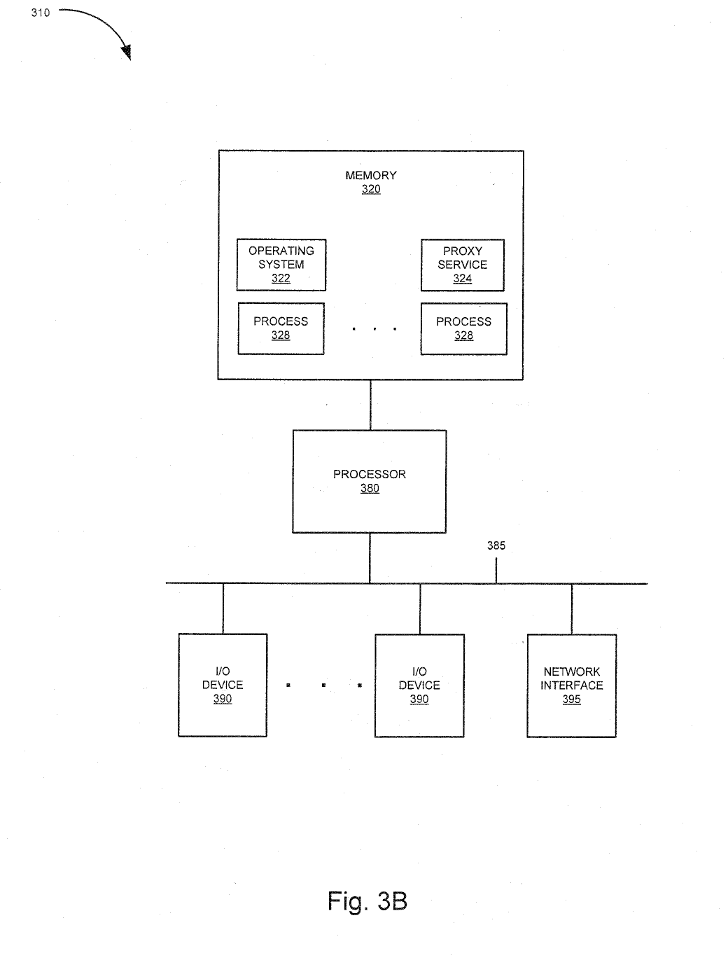

FIG. 3A is a block diagram of an embodiment of domain controller 300. Domain controller 300 comprises a memory 330, a processor 340 coupled to one or more I/O devices 360 and a network interface 370 via an I/O bus 350. The I/O devices 360 are conventional I/O devices, such as disk units, keyboards, display devices, and the like. The network interface 370 comprises circuitry configured to interface the domain controller directly with the network 100 or through policy portal proxy 310. To that end, the network interface 370 comprises conventional interface circuitry that incorporates signal, electrical, and mechanical characteristics and interchange circuits needed to interface with the physical media of the network 100 and protocols running over that media. The processor 340 is a conventional CPU configured to execute instructions and manipulate data contained in the memory 330. The memory 330 is a conventional RAM comprising, e.g., DRAM devices. The memory contains an operating system 332, policy services 334 and active directory 336. It should be noted that memory 330 may contain other processes 338 that are used to perform various functions on the domain controller 300.

The operating system 332 is a conventional operating system that comprises computer executable instructions and data configured to support the execution of processes, such as policy services 334. Specifically, operating system 332 is configured to perform various conventional operating system functions that, e.g., enable the processes to be scheduled for execution on the processor 340 as well as provide controlled access for various resources of the domain controller 300 such as memory 330, I/O devices 360 and network interface 370. An example of an operating system that may be used with the present invention on domain controller 300 is the Windows 2000 server operating system which is available from Microsoft Corporation.

The policy services 334 is a process comprising computer executable instructions that are configured to maintain various group policy settings contained in the active directory 336 that may be applied to a managed client 200 in accordance with aspects of the present invention. The active directory 336 is a datastructure that is configured to store information and settings, such as group policy settings, for a customer domain 120. The active directory comprises a hierarchical framework of objects which include resources, services and user/groups. The resources include such entities as printers. The services include such entities as email. The user/group objects contain information about user/groups associated with the customer domain 120. This information may include various group policy settings associated with the user/groups. An example of an active directory that may be used with the present invention is the Windows 2000 active directory which is available from Microsoft Corporation.

FIG. 3B is a block diagram of an embodiment of a policy portal proxy 310 that includes a memory 320, a processor 380 coupled to one or more I/O devices 390 and a network interface 395 via an I/O bus 385. The I/O devices 390 are conventional I/O devices, such as disk units, keyboards, display devices, and the like. The network interface 395 comprises circuitry configured to interface the policy portal proxy with the network 100. To that end, the network interface 390 comprises conventional interface circuitry that incorporates signal, electrical, and mechanical characteristics and interchange circuits needed to interface with the physical media of the network 100 and protocols running over that media. The processor 380 is a conventional CPU configured to execute instructions and manipulate data contained in the memory 320. The memory 320 is a conventional RAM comprising, e.g., DRAM devices. The memory contains an operating system 322 and proxy services 324. It should be noted that memory 320 may contain other processes 328 that are used to perform various functions on the policy portal proxy 310.

The operating system 322 is a conventional operating system that comprises computer executable instructions and data configured to support the execution of processes, such as proxy services 324. Specifically, operating system 322 is configured to perform various conventional operating system functions that, e.g., enable the processes to be scheduled for execution on the processor 380 as well as provide controlled access for various resources of the policy portal proxy 310 such as memory 320, I/O devices 390 and network interface 395.

The proxy services 324 is a process comprising computer executable instructions that are configured to retrieve group policy settings from the domain controller 300 and transfer the retrieved settings to the policy portal 400.

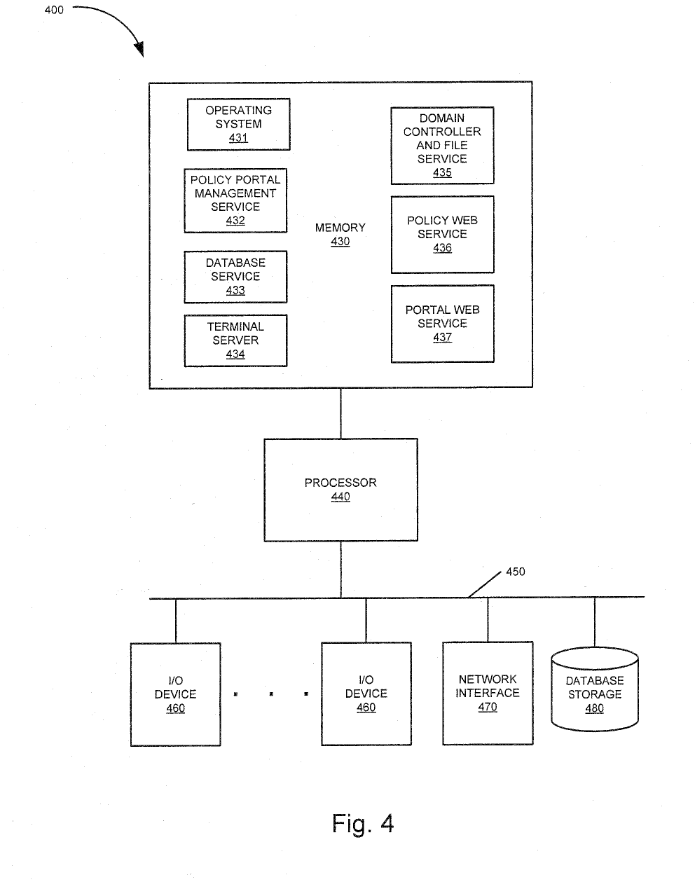

FIG. 4 is a block diagram of an embodiment of a policy portal server 400. Server 400 comprises a memory 430, a processor 440 coupled to one or more I/O devices 460, a network interface 470 and a database storage 480. The processor 440 is a conventional CPU configured to execute instructions and manipulate data contained in memory 430. The I/O devices 460 are conventional I/O devices such as keyboards, storage units, display devices and the like. The network interface 470 is a conventional network interface that is configured to interface the policy portal server 400 with the network 100. To that end, the network interface 470 comprises conventional interface circuitry that incorporates signal, electrical characteristics and interchange circuits needed to interface with the physical media of the network and the protocols running over that media. The database storage 480 is a conventional storage medium configured to hold a structured query language (SQL) database. As will be described further below, this database comprises, interalia, group policy settings that may be applied to the managed clients 200.

The memory 430 is a conventional RAM comprising e.g., DRAM devices. Memory 430 contains an operating system 431, policy portal management service 432, database service 433, terminal server 434, domain controller and file service 435, policy web service 436 and portal web service 437. The operating system 431 is a conventional operating system configured to schedule the execution of processes such as policy portal management service 432, database service 433, terminal server 434, domain controller and file service 435, policy web service 436 and portal web service 437 on processor 440 as well as provide controlled access to various resources associated with policy portal server 400, such as the I/O devices 460, database storage 480 and network interface 470. An example of an operating system that may be used with the present invention is the Windows 2000 server operating system.

The policy portal management service 432 comprises computer executable instructions configured to receive policy settings from the various customer domains 120 and direct the database services 433 to store the acquired policy settings in a database contained in database storage 480. The database service 433 comprises computer executable instructions that are configured to maintain group policy settings in the database on database storage 480. The terminal server 434 comprises computer executable instructions configured to enable administrator nodes 160 to gain access to the group policy settings contained in the database on data storage 480. The domain controller and file service 435 comprises computer executable instructions for implementing a domain controller at the policy portal 150. The policy web service 436 comprises computer executable instructions configured to implement a web service that is used by the managed clients to gain access to policy settings maintained at the policy portal 150. The portal web service 437 comprises computer executable instructions configured to implement a web server that enables the administrator nodes 160 to gain access to various group policy settings to maintain these group policy settings at the policy portal 150.

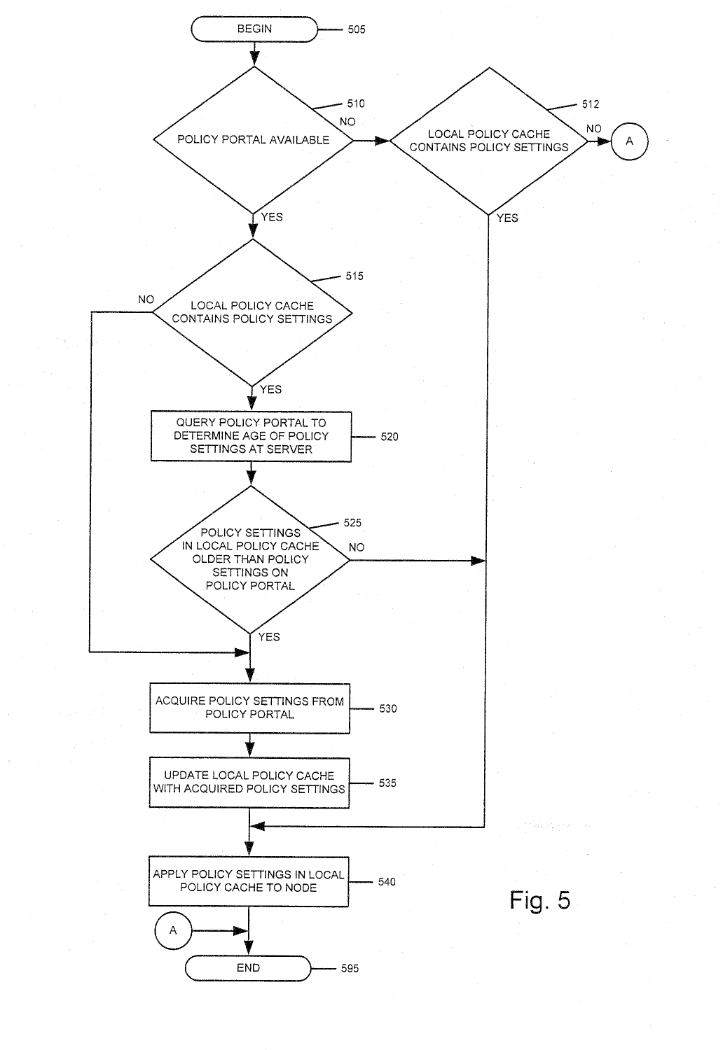

FIG. 5 is a flowchart of a sequence that may be used to configure a managed client 200 to acquire policy settings for the managed client from the policy portal 150 and apply the policy settings to the managed client 200. The sequence begins at step 505 and proceeds to step 510 where a check is performed to determine if the policy portal 150 is available. Illustratively, the policy portal is available if the client 200 is able to connect with the policy portal 150. If the policy portal is not available, the sequence proceeds to step 512 where a check is performed to determine if the group policy cache 236 contained in the client 200 contains the policy settings for that client. If not, the sequence proceeds to step 595 where the sequence ends. Otherwise, if the group policy cache 236 at the client 200 contains the policy settings for the client 200, the sequence proceeds to step 540.

At step 510, if the policy portal is available, the sequence proceeds to step 515 where a check is performed to determine if the group policy cache 236 on the client 230 contains the client's policy settings. If not, the sequence proceeds to step 530. Otherwise the sequence proceeds to step 520 where the policy portal 150 is queried to determine the age of the policy settings for the client 200 at the policy portal 150. Illustratively, the client 200 generates a message which is then transferred via the network 170 to the policy portal 150 where it is received at the firewall 130 and forwarded to the policy portal server 400. The policy portal server 400 examines the message and determines that the client is requesting information about the age of the group policy settings maintained at the policy portal 150. The policy portal server 400 generates a message containing the requested information and forwards the message via the network 170 to the client 200.

At step 525, the client 200 determines if the policy settings in its group policy cache 236 are older than the policy settings on the policy portal 150. If the settings in the group policy cache 236 are not older than the settings at the policy portal 150, the sequence proceeds to step 540. Otherwise, the sequence proceeds to step 530 where the client 200 acquires the policy settings for the client from the policy portal 150. Illustratively, the client generates a message containing a request for the policy settings and forwards the message via the network 170 to the policy portal 150. The policy portal 150 receives the message at the firewall 130 which forwards the message to the policy portal server 400. The policy portal server queries its database 480 and reads the policy settings for the client 200. The policy portal 150 then transfers the policy settings from the policy portal server 150 via the network to the client 200.

The client 200, at step 535, updates its group policy cache 236 with the policy settings acquired from the policy portal 150. At step 540 the client 200 applied the policy settings contained in the group policy cache 236 to the client 200. The mechanism for applying the policy settings replicates the conventional manner in that each policy setting type is processed in sequence and for each policy setting type, separate logic that knows how to interpret and apply the setting type is used. The setting types and how they are generally applied are well documented and understood. The sequence ends at 595.

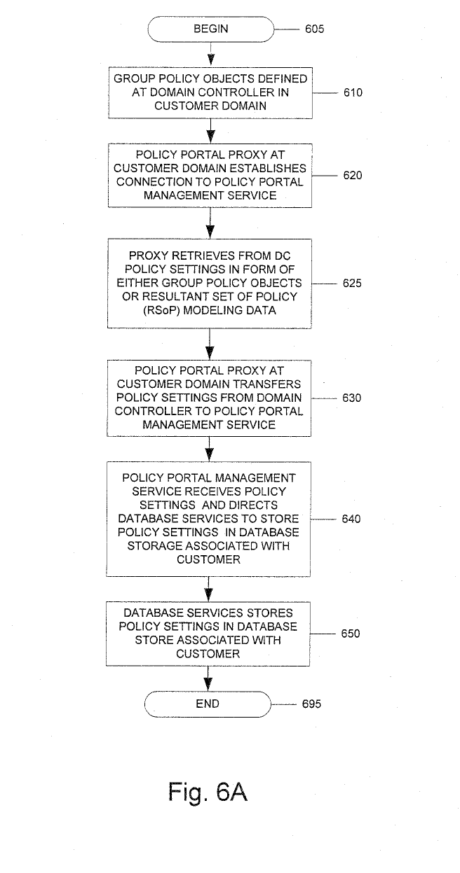

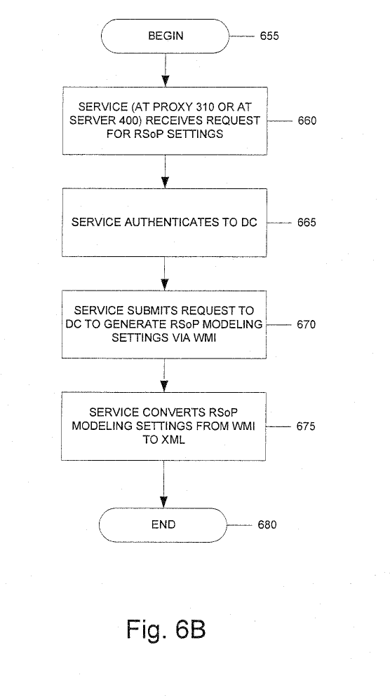

FIG. 6A is a flowchart of a sequence that may be used to download group policy settings from a customer domain 120 to the policy portal 150. The sequence begins at 605 and proceeds to step 610 where group policy objects are defined at the customer domain 120. Next, at step 620, the policy portal proxy 310 at the customer domain 120 establishes a connection to the policy portal management service 432 at the policy portal 150. At step 625, the policy portal proxy 310 queries the domain controller 300 and retrieves from the domain controller the policy settings in the form of either group policy objects or resultant set of policy (RSoP) modeling data.

FIG. 6B is a flowchart that illustrates a sequence that may be used to obtain the RSoP results. Beginning at 655, the sequence proceeds to step 660 where a service at the policy portal proxy 310 (FIG. 3B) or server 400 (FIG. 4) receives a request for the RSoP results. At step 665, the service authenticates to the domain controller 300 and at step 670 submits a request to the domain controller to generate RSoP modeling settings via Windows Management Interface (WMI). At step 675, the service converts the RSoP modeling settings from WMI to XML. The sequence ends at 680.

Referring again to FIG. 6A, at step 630, the policy portal proxy 310 transfers the group policy settings from the customer domain 120 via the network 170 to the policy portal management service 432. The policy portal management service 432 receives the group policy settings and directs the database service 433 to store the settings in a database on database storage 480 at step 640. Illustratively, the group policy settings are stored in a manner that associates the customer domain with the group policy settings. At step 650 the database services stores the group policy settings in a database contained in the database storage 480. The sequence ends at 695.

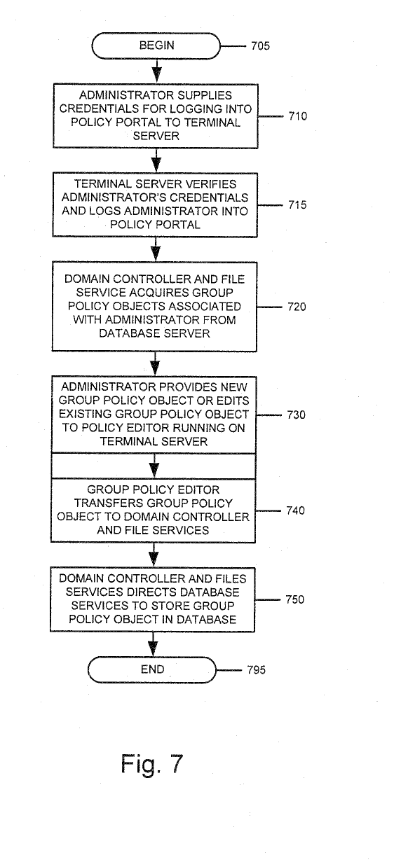

FIG. 7 is a flowchart of a sequence that may be used to associate policy objects with particular managed clients. The sequence begins at step 705 and proceeds to step 710 where an administrator 160 supplies credentials to the terminal server 434 for logging into the policy portal 150. At step 715, the terminal server 434 verifies the administrator's credentials and logs the administrator into the policy portal 150. At step 720, the domain controller and File service 435 acquires the group policy objects from the database storage 480. At step 730 the administrator 160 provides either a new group policy object or edits an existing group policy object usign a policy editor that is running on the terminal server 434. At step 740, the group policy editor transfers the new or edited group policy object to the domain controller and file service. At step 750, the domain controller and file service directs the database service 433 to store the group policy object in the database contained in the database storage 480. The sequence ends at step 795.

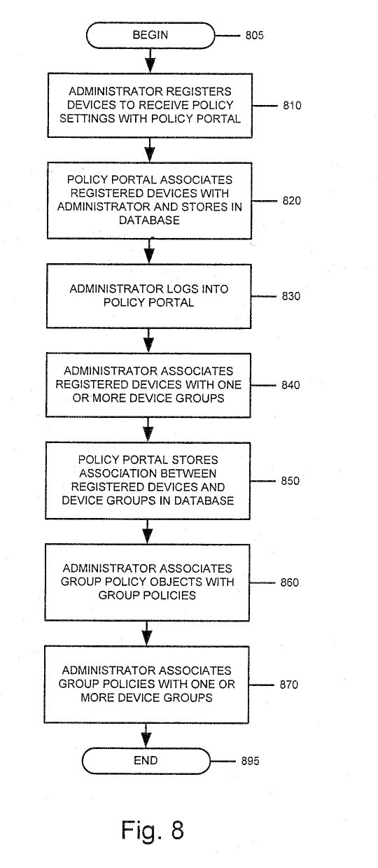

FIG. 8 is a flowchart of a sequence that may be used to associate registered devices (e.g., managed clients 200) with group policy objects contained in the database in the policy portal 150. The sequence begins at step 805 and proceeds to step 810 where an administrator 160 registers devices, such as managed clients 200, with the policy portal 150. At step 820, the policy portal 150 associates the registered devices with the administrator and stores the association in the database contained in the database storage 480. Next, at step 830, the administrator logs into the policy portal 150. At step 840, the administrator associates one or more of the registered devices with one or more device groups. The policy portal, at step 850, stores the association of the register devices with the device groups in a database. Next, at step 860, the administrator associates a group policy objects with group policies. At step 870 the administrator associates the group policies with one or more device groups. The sequence ends a step 895.

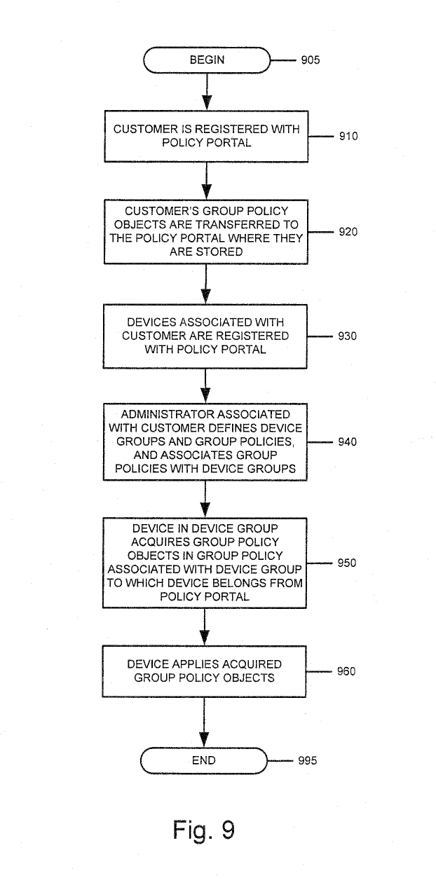

FIG. 9 is a flowchart of a sequence that may be used to apply policies to a managed client 200. The sequence begins at step 905 and proceeds to step 910 where a customer associated with the managed client is registered with the policy portal 150. Next, at step 920, the customer's group policy objects are downloaded from the customer's domain 120 to the policy portal 150, as described above. At step 930, devices associated with the customer are registered with the policy portal 150, as described above. At step 940, an administrator 160 associated with the customer defines the device groups and group policies and associates the group policies with the device groups as described above. At step 950, a device in a device group acquires the group policy objects in a group policy associated with the device group from the policy portal 150 as described above. At step 960 the device applies the acquired group policy objects as described above. The sequence ends at step 995.

For example, referring to FIG. 1 assume managed client 200a is associated with customer domain 120a and that policy settings established at customer domain 120a are to be applied to managed client 200a. Now assume that the group policy settings at the customer domain 120a are to be downloaded to the policy portal 150. Group policy objects are defined at the domain controller 300a in the customer domain 120a (step 610). The policy portal proxy 310a establishes a connection via WAN 170 to the policy portal management service 432 at the policy portal server 400 (step 620). The policy portal proxy 310 then transfers the group policy objects contained in the active directory 336 of the domain controller 300a via the network 170 to the policy portal management service 432 (step 630). The policy portal management service 432 receives the group policy objects and directs the database service 433 to store the group policy objects in a database contained in the database storage 480 in a manner that relates the customer associated With customer domain 120a with the group policy objects (step 640). The database service 433 then transfers the group policy objects that are associated with the customer to the database contained in the database storage 480 (step 650).

As noted above, the managed client needs to be registered with the policy portal 150, associated with a device group and the device group in turn associated with the group policies that are to be applied to the managed client 200a. Assume that an administrator at node 160 has been given the responsibility of registering the managed client 200a with the policy portal, associating with it a device group and further associating the device group with group policies that are to be downloaded to devices belonging to that group. The administrator registers managed client 200a with the policy portal 150 (step 810). The policy portal 150 associates the managed client 200a with the administrator and stores this information in the database 480 (step 820). Next, the administrator logs into the policy portal 150 (step 830) and associates managed client 200a with a device group (step 840). The policy portal 150 stores the association between the managed client 200a and the device group in the database 480 (step 850). The administrator then associates group policy objects stored in the database 480 with group policies (step 860). The administrator then associates a group policy with the managed client 200a (step 870). Note that the group policy objects contained in the group policy that is associated with the managed client 200a will be the group policies that are transferred from the policy portal 150 to the managed client 200a.

Now assume that the managed client 200a is powered on and begins booting its operating system 232. Further assume that the policy update services 234 is executed at the boot up time to ensure that the group policies associated with managed client 200a are applied to the client 200a. The policy update services 234 at client 200a first checks to see if the policy portal 150 is available (step 510). Assume that the policy portal is available. The policy update services 234 checks the group policy cache 236 to determine if it contains policy settings for device 200a (step 515). Assume that the group policy cache 236 for client 200a does not contain the policy settings for the client 200a. The policy update services 234 then acquires the policy settings for the client 200a from the policy portal 150 (step 530). Illustratively, the policy update services 234 generates a message requesting the policy settings for client 200a from the policy portal 150. The message travels via network 100 to the policy portal 150 and is received by the policy portal service server 400. The message is received by the policy web service 436 which directs the database service 433 to read the policy group settings associated with the client 200a from database 480. The policy web service 436 then transfers the policy group information via the network to the client 200a. The policy update services process 234 at client 200a receives the group policy information and updates the group policy cache 236 with the acquired group policy settings (step 535). The policy update services 234 then applies the group policy settings contained in the group policy cache 236 to the client 200a (step 540).

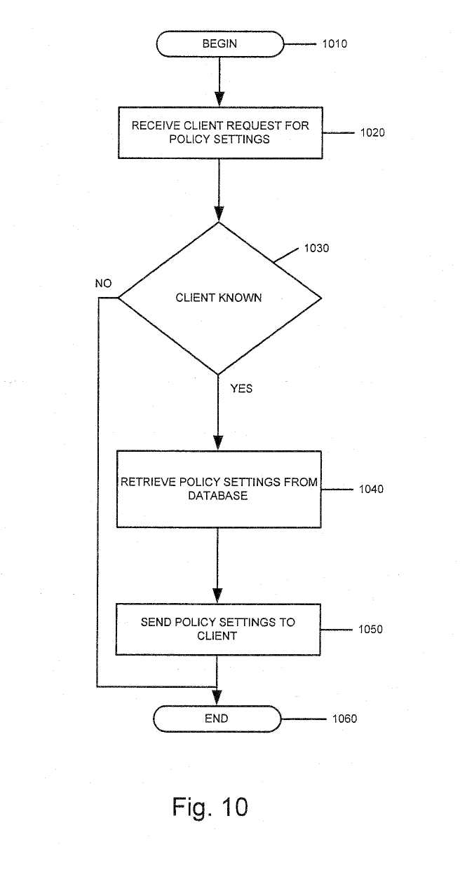

FIG. 10 illustrates a flowchart of a sequence that may be used by a policy portal 150 to update policy settings of a managed client 200 (FIG. 1), corresponding to the acquisition step 530 in FIG. 5. The sequence begins at step 1010 and proceeds to step 1020 where the policy portal 150 receives a request for policy settings from client 200, Illustratively, the client 200 generates a message containing a request for policy settings which is transferred via network 170 to the policy portal 150. The policy portal 150 receives the message at firewall 130 which forwards the message to policy portal server 400. The policy portal server 400 at step 1030 determines if the client 200 is known, i.e., registered with the policy portal server 400. If the client 200 is not known, the sequence proceeds to step 1060. Otherwise, the sequence proceeds to step 1040 where the policy portal server 400 retrieves the policy settings from its database 480. At step 1050 the policy portal server 400 sends the retrieved policy settings to the client 200 over the network 170. The sequence ends at step 1060.

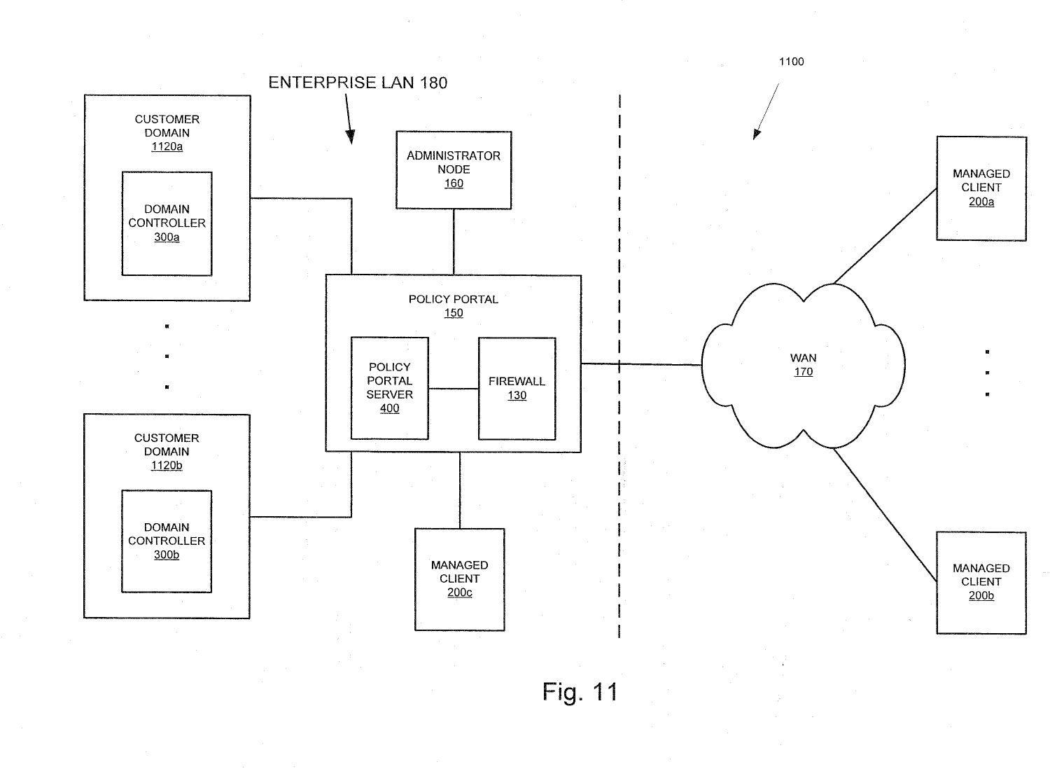

The embodiment described in connection with FIG. 1 can be understood as following an application service provider (ASP) model. FIG. 11 illustrates a high level block diagram of a second embodiment of an example communication network 1100. The network embodiment is an enterprise-based configuration that includes an enterprise local area network 180, network 170 and one or more managed clients 200a, 200b. In particular, the enterprise local area network 180 includes one or more domain controllers 300, policy portal server 400, firewall 130 and administrator node 160. In addition, the enterprise local area network 180 may include one or more managed clients 200c.

In the embodiment of FIG. 11, the managed client 200 communicates with the policy portal 150 to request group policy settings in a similar manner as described earlier with respect to the ASP model of FIG. 1. One difference relates to the manner in which the group policy settings are communicated between the customer domain 1120 and the policy portal 150. Whereas group policy settings are pushed to the policy portal in the ASP model, the group policy settings are pulled from the domain controller 300 by the policy portal in the enterprise model of FIG. 11.

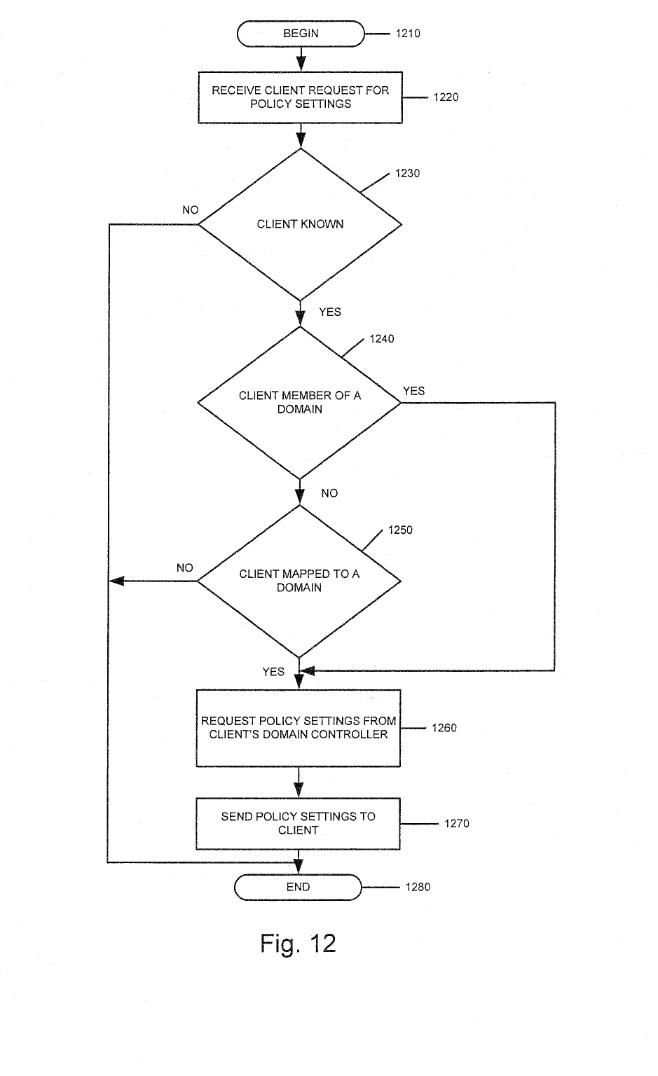

FIG. 12 illustrates a flowchart of a sequence that may be used by the policy portal 150 to update policy settings of a managed client 200 in relation to the embodiment of FIG. 11. The sequence begins at step 1210 and proceeds to step 1220 where the policy portal 150 receives a request for policy settings from client 200. Illustratively, the client 200 generates a message containing a request for policy settings which is transferred via network 170 to the policy portal 150 (FIG. 11). The policy portal 150 receives the message at firewall 130 which forwards the message to policy portal server 400. The policy portal server 400 at step 1230 determines if the client 200 is known, i.e., registered with the policy portal server 400. If the client 200 is not known, the sequence proceeds to step 1280. Otherwise, the sequence proceeds to step 1240 where the policy portal server 400 determines if the client 200 is a member of a customer domain. If the client is a member of a domain, the sequence continues at step 1260. Otherwise, the sequence proceeds to step 1250 where the policy portal server 400 determines if the client 200 is mapped to a domain. If the client is not mapped to a domain, the sequence proceeds to step 1280. Otherwise, the process continues at step 1260 where the policy portal server 400 requests the policy settings from the client's domain controller 300. At step 1270 the policy portal server 400 sends the retrieved policy settings to the client 200 over the network 170. The sequence ends at step 1280.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method comprising:
storing group policy settings in a local policy cache of a client computer system; and
applying the group policy settings from the local policy cache to the client computer system.

2. The method of claim 1 wherein storing includes:
acquiring group policy settings from a policy portal over a network connection; and
updating the local policy cache of the client computer system with the acquired group policy settings.

3. The method of claim 2 wherein the client computer system is without domain membership and is connected to an enterprise local area network.

4. The method of claim 2 wherein the client computer system is without domain membership and is connected to a wide-area network.

5. The method of claim 2 wherein the client computer system is a member of a customer domain and is connected to a wide-area network.

6. The method of claim 1 wherein storing includes:
querying a policy portal over a network connection to determine an age of group policy settings stored at the policy portal;
if the group policy settings in the local policy cache are older than the group policy settings stored at the policy portal, then acquiring the group policy settings from the policy portal and updating the local policy cache of the client computer system with the acquired group policy settings.

7. The method of claim 6 wherein the client computer system is without domain membership and is connected to an enterprise local area network.

8. The method of claim 6 wherein the client computer system is without domain membership and is connected to a wide-area network.

9. The method of claim 6 wherein the client computer system is a member of a customer domain and is connected to a wide-area network.

10. The method of claim 1 wherein storing includes:
determining whether the local policy cache contains group policy settings;
if the local policy cache does not contain group policy settings, then acquiring group policy settings from a policy portal and updating the local policy cache of the client computer system with the acquired group policy settings.

11. A method comprising:
receiving a request for group policy settings from a client computer system over a network connection;
determining a domain associated with the client computer system;
requesting group policy settings from a domain controller corresponding to the determined domain; and
sending the group policy settings to the client computer system in response to the client request.

12. A method comprising:
receiving a request for group policy settings from a client computer system over a network connection;
retrieving group policy settings associated with the client computer system from a policy settings database; and
sending the retrieved group policy settings to the client computer system in response to the client request.

13. The method of claim 12 further comprising:
storing group policy settings associated with the client computer system to the policy settings database upon receiving the policy settings from a policy portal proxy connected to a domain controller.

14. A method comprising:
retrieving group policy settings from a domain controller; and
sending the retrieved group policy settings to a server over a wide-area network connection.

15. The method of claim 14 wherein the group policy settings are in the form of group policy objects.

16. The method of claim 14 wherein the group policy settings are in the form of resultant set of policy modeling data.

17. Apparatus for managing group policy settings at a client computer system the apparatus comprising:
a local policy cache for storing group policy settings of the client computer system; and
a policy application configured to apply the group policy settings from the local policy cache to the client computer system.

18. The apparatus of claim 17 wherein the local policy cache is updated with group policy settings acquired from a policy portal over a network connection.

19. The apparatus of claim 18 wherein the group policy settings are acquired from the policy portal if the current group policy settings in the local policy cache are older than the group policy settings stored at the policy portal.

20. An apparatus for managing group policy settings on one or more client computer systems, the apparatus comprising:
a network interface configured to receive a request for group policy settings from a client computer system over a network connection;
a policy settings database configured to hold group policy settings; and
a processor configured to retrieve group policy settings associated with the requesting client computer system from the policy settings database and to send the retrieved group policy settings to the client computer system in response to the client request via the network interface.

21. The apparatus of claim 20 wherein the processor is further configured to:
store group policy settings associated with the client computer system to the policy settings database upon receiving the policy settings from a policy portal proxy connected to a domain controller.

22. An apparatus for managing group policy settings on one or more client computer systems, the apparatus comprising:
a network interface configured to receive a request for group policy settings from a client computer system over a network connection; and
a processor configured to determine a domain associated with the client computer system, request group policy settings from a domain controller corresponding to the determined domain and send the group policy settings to the client computer system in response to the client request via the network interface.

23. Apparatus comprising:
means for storing group policy settings in a local policy cache of a client computer system; and
means for applying the group policy settings from the local policy cache to the client computer system.

24. Apparatus comprising:
means for receiving a request for group policy settings from a client computer system over a network connection;
means for determining a domain associated with the client computer system;
means for requesting group policy settings from a domain controller corresponding to the determined domain; and
means for sending the group policy settings to the client computer system in response to the client request.

25. Apparatus comprising:
means for receiving a request for group policy settings from a client computer system over a network connection;
means for retrieving group policy settings associated with the client computer system from a policy settings database; and
means for sending the retrieved group policy settings to the client computer system in response to the client request.

26. Apparatus comprising:
means for retrieving group policy settings from a domain controller; and
means for sending the retrieved group policy settings to a server over a wide-area network connection.
